(19) United States
(12) Patent Application Publication
(10) Pub. No.: US 2009/0009507 A1
(43) Pub. Date: Jan. 8, 2009

(54) Display controller and method of controlling the same

(75) Inventor: Masahiro Tanabe, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/155,710

(22) Filed: Jun. 9, 2008

(30) Foreign Application Priority Data
Jul. 6, 2007 (JP) 2007-178109

(51) Int. Cl. G09G 5/00

(52) U.S. Cl. 345/213

(57) ABSTRACT

A display controller according to one embodiment of the present invention includes a control pulse generating part outputting control pulse to a data line controller and a scan line controller driving a display panel, and an intermittent clock generating part generating an intermittent clock synchronized with a reference clock and setting a clock interval based on a timing setting value setting a timing at which the control pulse changes in a predetermined period.

### BACKGROUND OF THE INVENTION

1. Field of the Invention

The present invention relates to a display controller and a method of controlling the same. More particularly, the present invention relates to a display controller controlling a display device using an intermittent clock based on a control timing of the display device and a method of controlling the same.

2. Description of Related Art

Hitherto, a display panel (liquid crystal panel) such as a TFT (thin film transistor) has often been used as a display device. Since the liquid crystal panel is thin and light, it is often used in a mobile device as well. In the liquid crystal panel mounted on the mobile device, the number of pixels is changed in accordance with a usage state in order to reduce power consumption. One example of the display controller controlling the number of pixels that can be displayed on the liquid crystal panel is disclosed in Japanese Unexamined Patent Application Publication No. 2005-43914.

FIG. 5 shows a block diagram of a related display controller 102 disclosed in Japanese Unexamined Patent Application Publication No. 2005-43914. The display controller 102 sends data to a CPU (central processing unit) 101, receives data from the CPU 101, and controls a liquid crystal panel 103 based on this data. In the liquid crystal panel 103, the pixels are arranged in matrix. The display controller 102 outputs a gradation signal to pixels arranged in columns by a data line controller 127. A scan line controller 128 selects pixels arranged in rows. The display controller 102 selects a pixel row of the liquid crystal panel 103 and provides the gradation signal for each selected pixel row. Accordingly, the image is rendered for each pixel row in the liquid crystal panel 103, and when rendering for all the rows is completed, the image is displayed on the whole display of the liquid crystal panel 103. Now, the period in which rendering of one pixel row is performed is called one scanning period, and an inverse number of the period in which the rendering of the whole display is performed is called one frame frequency.

The display controller 102 changes the settings of the reference clock generating part 123 and the timing generating part 124 so as to be able to change the length of one scanning period and one frame frequency. The reference clock generating part 123 generates a reference clock which is generated by dividing a frequency of an original clock input from an outside or generated inside. A frequency dividing ratio of the reference clock generating part 123 is set based on the value stored in the control register 122 and the frequency of the reference clock can be changed by changing the frequency dividing ratio. Further, the timing generating part 124 receives the number of driving pixel rows and the number of reference clocks in one scanning period from the control register 122 and generates a frame pulse (vertical synchronizing signal) Vsync, a line pulse (horizontal synchronizing signal) Hsync, and a control pulse synchronized with one scanning period based on the received data. The data line controller 127 and the scan line controller 128 operate based on these pulse signals. The control pulse includes a gate EN signal designating controllable period of pixels, a precharge signal designating precharge period of the data line, a RED_SW signal designating controllable period of the pixel of red gradation, a GREEN_SW signal designating controllable period of the pixel of green gradation, and a BLUE_SW signal designating controllable period of the pixel of blue gradation.

FIG. 6 shows a timing chart to describe the problem in an operation of the display controller 102, and the operation of the display controller 102 will be described with reference to FIG. 6. The timing chart shown in FIG. 6 indicates a first one scanning period of one frame period. As shown in FIG. 6, the display controller 102 outputs the precharge signal, the red gradation signal (RED output), the green gradation signal (GREEN output), and the blue gradation signal (BLUE output) to the data line in one scanning period. These outputs are supplied to each pixel when the precharge signal, the RED_SW signal, the GREEN_SW signal, and the BLUE_SW signal are in high level. Each voltage level of the precharge output, the RED output, the GREEN output, and the BLUE output is stable at a falling point of the precharge signal, the RED_SW signal, the GREEN_SW signal, and the BLUE_SW signal.

FIG. 7 shows a timing chart when the number of pixel rows shown in FIG. 6 is increased without changing one frame frequency. In this case, the length of one scanning period decreases. According to this, the timing generating part 124 generates the pulse signal where the relation between the timing at which the pulse signal changes and the timing of the reference clock is changed. This pulse signal has a shorter high-level period than the example shown in FIG. 6. However, since the high-level period of each pulse signal becomes shorter, the precharge signal, the RED_SW signal, the GREEN_SW signal, and the BLUE_SW signal start to fall before each voltage level of the precharge output, the RED output, the GREEN output, and the BLUE output is stable. Therefore, the gradation signal cannot be properly supplied to each pixel.

In such a case, the display controller 102 increases the frequency of the reference clock and improves the resolution of the control timing of the pulse signal generated by the timing generating part 124. FIG. 8 shows a timing chart in such a case. As shown in FIG. 8, the resolution of the control timing of the pulse signal is improved by increasing the frequency of the reference clock. Accordingly, the precharge signal, the RED_SW signal, the GREEN_SW signal, and the BLUE_SW signal start to fall after each voltage level of the precharge output, the RED output, the GREEN output, and the BLUE output become stable.

From the above description, the display controller 102 changes the relation between the frequency of the reference clock or the reference clock and the timing at which the pulse signal changes depending on the number of pixel rows controlled in one frame period. Accordingly, the display controller 102 is able to generate the optimal control pulse in accordance with the display state of the liquid crystal panel 103.

However, in recent years, the number of pixels for the liquid crystal used for the mobile device has been increasing to display the high-definition image. Therefore, the length of one scanning period has been made shorter. When such a liquid crystal panel is controlled by a related display controller 102, the frequency of the reference clock needs to be increased. In other words, in the related display controller 102, the frequency of the reference clock increases as the liquid crystal panel that is to be controlled becomes finer, which increases power consumption of the timing generating part 124.

### SUMMARY

A display controller according to one aspect of the present invention includes a control pulse generating part outputting control pulse to a data line controller and a scan line controller driving a display panel, and an intermittent clock generating part generating an intermittent clock synchronized with a reference clock and setting a clock interval based on a timing setting value setting a timing at which the control pulse changes in a predetermined period.

According to the display controller of the present invention, the control pulse is generated based on the intermittent clock where the clock interval is set based on the timing setting value setting the timing at which the control pulse changes. Accordingly, the operating frequency of the control pulse generating part generating the control pulse corresponds to the frequency of the intermittent clock having lower frequency than the reference clock. Since the control pulse can be generated with low operating frequency, the display controller according to the present invention can reduce power consumption compared with a related display controller. Further, it is possible to suppress the increase of the power consumption in accordance with the increase of the operating frequency by operating the control pulse generating part based on the frequency of the intermittent clock even when the pixel row that is to be displayed is increased.

A method of controlling a display controller according to another aspect of the present invention includes controlling a data line controller and a scan line controller driving a display panel by using a control pulse, the method including generating an intermittent clock synchronized with a reference clock and including an interval based on a timing setting value setting a timing at which the control pulse changes, and generating the control pulse based on the intermittent clock.

According to the method of controlling the display controller of the present invention, the control pulse can be generated based on the intermittent clock having lower frequency than the reference clock. Accordingly, the display controller according to the present invention can generate the control pulse with reduced power consumption compared with the related display controller. Further, it is possible to suppress the increase of the power consumption in accordance with the increase of the operating frequency by generating the control pulse based on the intermittent clock even when the pixel row that is to be displayed increases.

According to the display controller and the method of controlling the same of the present invention, it is possible to generate the control pulse controlling the data line controller and the scan line controller with reduced power consumption.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram of a display controller according to a first embodiment;

FIG. 2 is a circuit diagram of an intermittent clock generating part according to the first embodiment;

FIG. 3 is a timing chart of an operation of the intermittent clock generating part according to the first embodiment;

FIG. 4 is a timing chart of an operation of the display controller according to the first embodiment;

FIG. 5 is a block diagram of a related display controller;

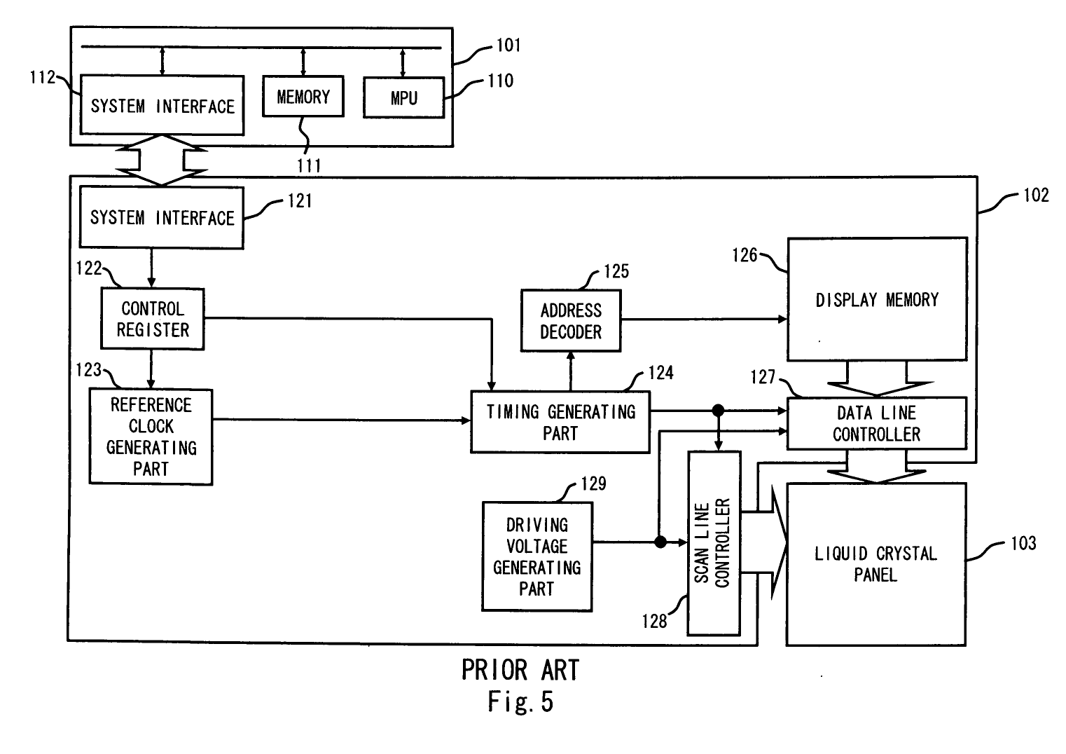

FIG. 6 is a timing chart to describe the problem in an operation of the related display controller;

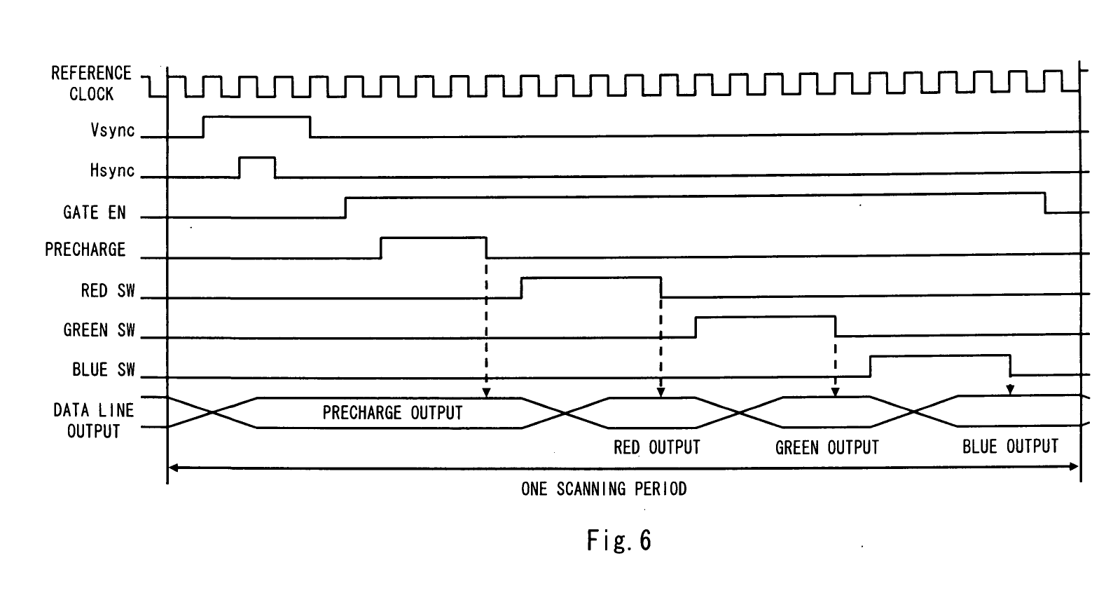

FIG. 7 is a timing chart to describe the problem in an operation of the related display controller; and

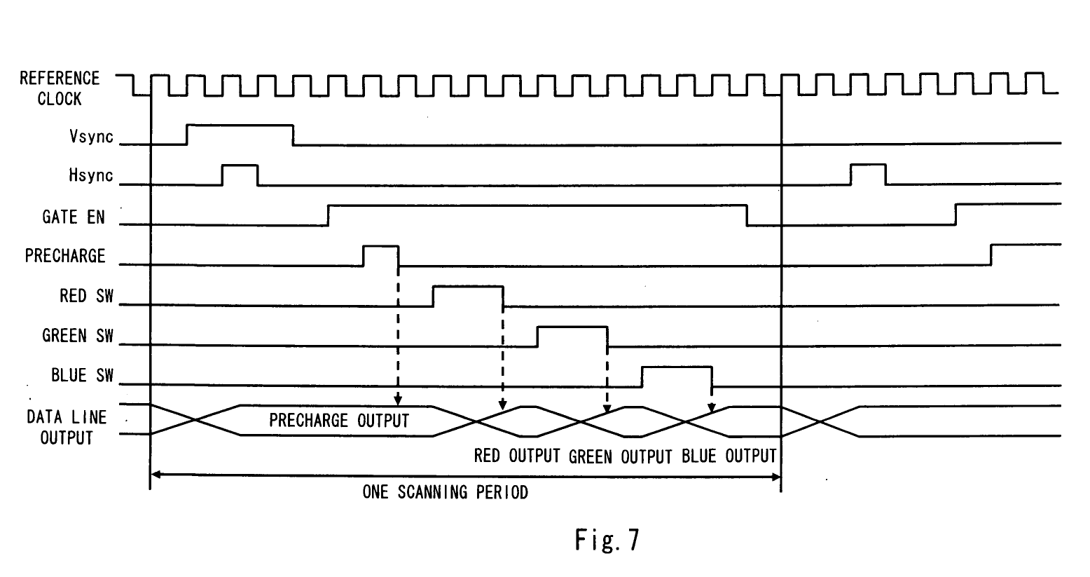

FIG. 8 is a timing chart to describe the problem in an operation of the related display controller.

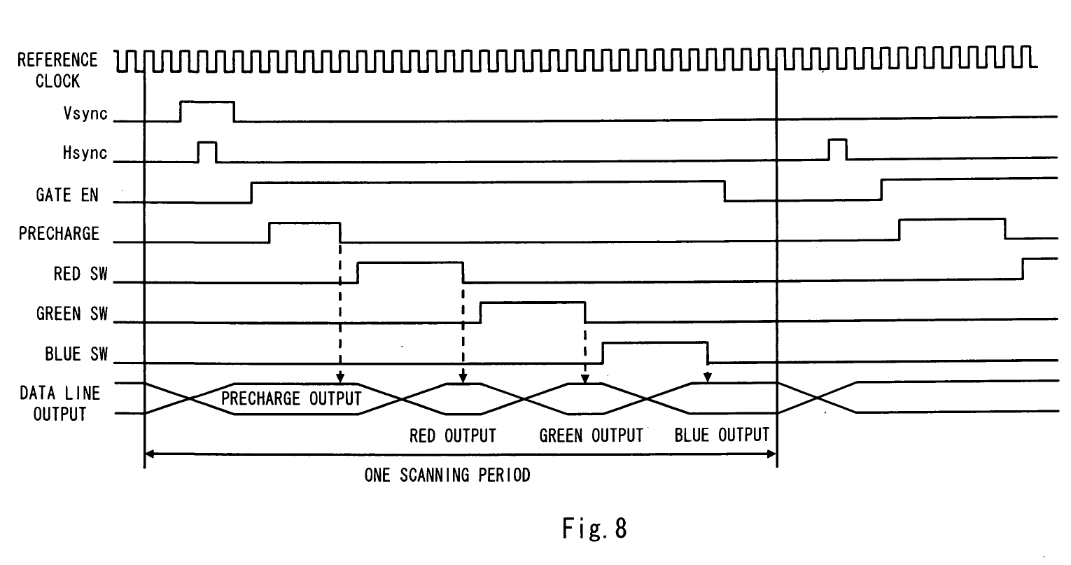

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

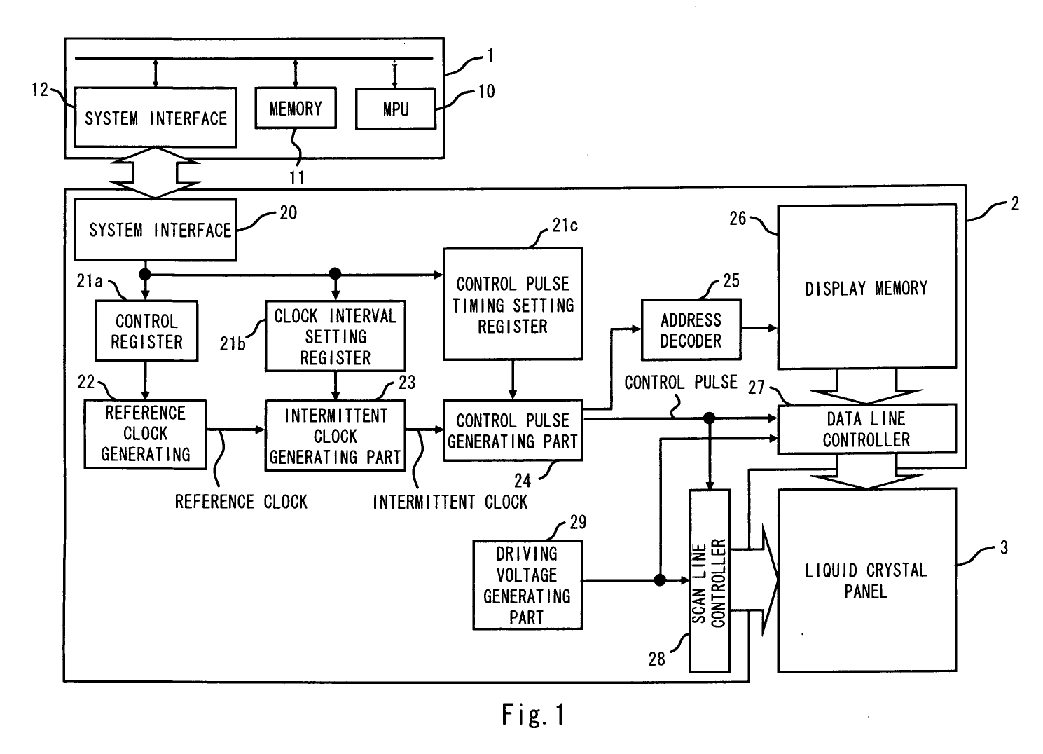

The embodiment of the present invention will be described in detail with reference to the drawings. FIG. 1 shows a display system according to the first embodiment. The display system includes a CPU (central processing unit) 1, a display controller 2, and a display panel (liquid crystal panel) 3. The CPU 1 processes an image to be displayed on the liquid crystal panel 3 and generates an image data, for example. The display controller 2 is the display controller according to the present invention, and controls the liquid crystal panel 3 according to the image data transmitted from the CPU. The liquid crystal panel 3 includes TFT (thin film transistor) or the like, for example, and includes pixels arranged in lattice.

One pixel includes a red pixel displaying red color, a green pixel displaying green color, and a blue pixel displaying blue color, for example. The liquid crystal panel 3 displays one pixel by emitting each pixel of red, green, and blue in accordance with a gradation set by an image data. In this pixel, only one scan line is connected for each row, and the conduction state is controlled for each row. Further, only one data line is connected for each column, and the gradation signal is provided for each column in accordance with the image data. In the following description, a predetermined period in which rendering of one pixel row is performed is called one scanning period, and an inverse number of the period in which the rendering of the whole display is performed is called one frame frequency.

Now, the display controller 2 will be described in detail. The display controller 2 includes a system interface 20, a control register 21a, a first setting register (clock interval setting register, for example) 21b, a second setting register (control pulse timing setting register, for example) 21c, a reference clock generating part 22, an intermittent clock generating part 23, a control pulse generating part 24, an address decoder 25, a display memory 26, a data line controller 27, a scan line controller 28, and a driving voltage generating part 29.

The system interface 20 is connected to a system interface 12 mounted on the CPU 1, and transmits and receives data between the CPU 1 and the display controller 2. The control register 21a stores a frequency dividing ratio of a clock in the reference clock generating part 22. The clock interval setting register 21b stores a timing setting value setting a clock interval of the intermittent clock generated by the intermittent clock generating part 23 and a number of reference clocks input to the intermittent clock generating part 23 in one scanning period (the number of clocks of one scanning period). The control pulse timing setting register 21c stores a relation between a timing at which the control pulse generated by the control pulse generating part 24 is changed and an intermittent clock input to the control pulse generating part 24.

The reference clock generating part 22 generates a reference clock used in the display controller 2 from an original clock input from an outside or generated inside the reference clock generating part. The reference clock is a clock obtained by dividing a frequency of the original clock, for example. The frequency dividing ratio is stored in the control register 21a. The intermittent clock generating part 23 generates the intermittent clock synchronized with the reference clock and including clock interval set by the timing setting value stored in the clock interval setting register 21b. The intermittent clock generating part 23 will be described later in detail.

The control pulse generating part 24 generates a control pulse based on the intermittent clock. The control pulse is supplied to the data line controller 27 and the scan line controller 28. The data line controller 27 and the scan line controller 28 control the liquid crystal panel 3 at a timing based on the control pulse. The control pulse will be described later in detail.

The control pulse generating part 24 generates a writing address and a reading address of the display memory and outputs these addresses to the address decoder 25. The address decoder 25 decodes the writing address and designates the address stored by the display data input from the outside in the display memory 26. The address decoder 25 decodes the reading address and designates the display data output to the data line controller 27 out of the display data stored in the display memory 26. The display memory 26 is a memory storing the display data displayed on the liquid crystal panel 3.

The data line controller 27 outputs a gradation signal (gradation voltage, for example) driving a data line of the liquid crystal panel 3 based on the display data input from the display memory. The gradation voltage is generated for each color element of red, green, and blue, for example, and is applied to each pixel in accordance with the color element in a predetermined period driving one pixel line of the liquid crystal panel 3 (hereinafter this time is called one scanning time). The timing at which the gradation signal is supplied to each pixel is determined by the control pulse. Note that the data line controller 27 operates based on the voltage generated by the driving voltage generating part 29.

The scan line controller 28 controls a pixel row of the liquid crystal panel at a timing based on the control pulse. At this time, the scan line controller 28 controls conduction state of the switch of the pixel, for example. Note that the scan line controller 28 operates based on the voltage generated at the driving voltage generating part 29. The relationship between the data line controller 27 and the scan line controller 28, and the control pulse will be described later in detail.

The driving voltage generating part 29 boosts power supply voltage input from an outside for example, and generates sufficient voltage for the data line controller 27 and the scan line controller 28 to drive the liquid crystal panel 3. The driving voltage generating part 29 is a step-up circuit such as a charge pump circuit for example, which can generate a plurality of voltages.

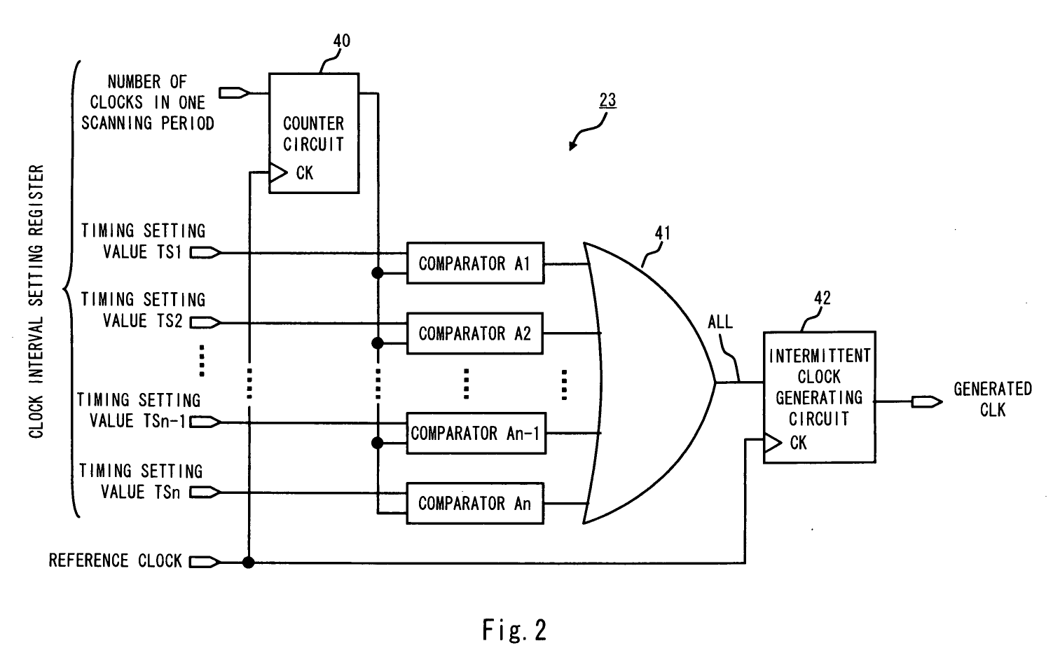

Now, the intermittent clock generating part 23 will be described in detail. FIG. 2 shows a circuit diagram of the intermittent clock generating part 23. As shown in FIG. 2, the intermittent clock generating part 23 includes a counter circuit 40, comparators A1 to An, an OR circuit 41, and an intermittent clock generating circuit 42. Note that the number of clocks in one scanning period and timing setting values TS1 to TSn are input to the intermittent clock generating part 23 as the timing setting values, for example.

The counter circuit 40 counts the number of clocks of the reference clock and outputs the count value. When the count value of the reference clock reaches the number of clocks in one scanning period, the counter circuit 40 resets the count value. Each of the timing setting values TS1 to TSn is input to each of the comparators A1 to An, respectively. The comparators A1 to An compare the count values output from the counter circuit 40 with the timing setting values, and output “1” when the count value and the timing setting value are equal to each other. Here, n in the comparator An and the timing setting value TSn corresponds to the number of times where the signal level of the control pulse changes in one scanning period, for example. The timing setting values TS1 to TSn are the values corresponding to the timing at which the control pulse changes. For example, when the number of clocks of the reference clock input in one scanning period is m, for example, it is set which clock of m reference clocks outputs the intermittent clock.

The OR circuit 41 outputs OR of the outputs of the comparators A1 to An. This output is transmitted to the intermittent clock generating circuit 42 as the ALL signal. The intermittent clock generating circuit 42 keeps the signal level of the ALL signal according to the rising of the reference clock to output the signal, which is the intermittent clock. Note that the intermittent clock generating circuit 42 is formed by a D flip-flop.

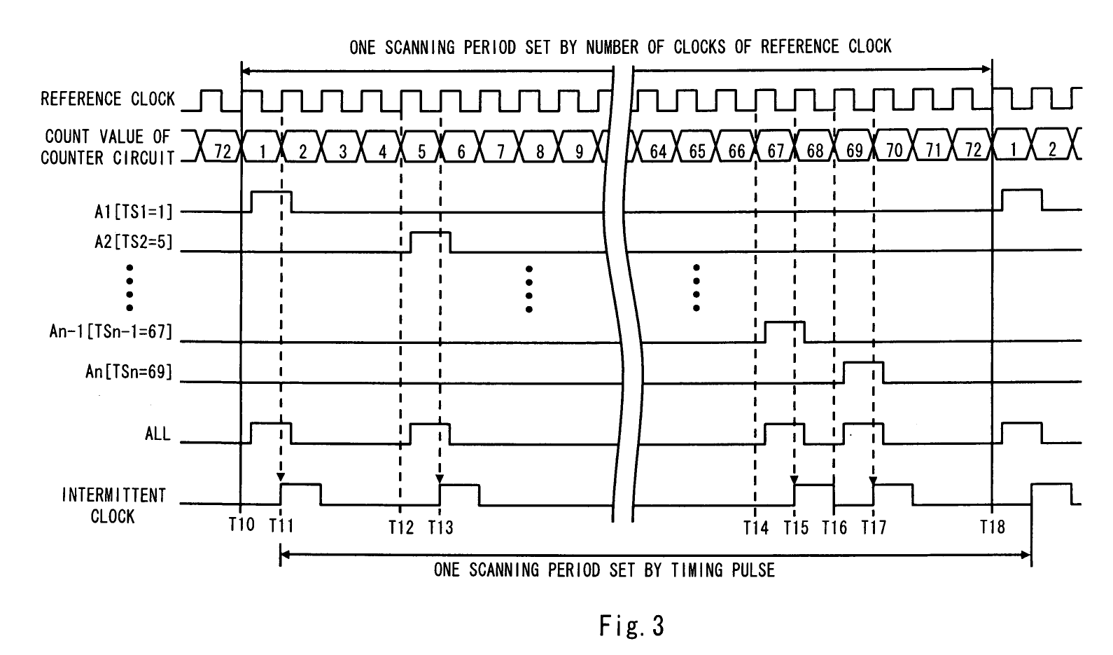

Now, the operation of the intermittent clock generating circuit 42 will be described. FIG. 3 shows a timing chart of the operation of the intermittent clock generating circuit 42. The timing chart of FIG. 3 shows the operation of the intermittent clock generating part 23 in one scanning period. In this example, 72 reference clocks are input in one scanning period, and the timing setting value TS1 is 1, the timing setting value TS2 is 5, the timing setting value TSn-1 is 67, and the timing setting value TSn is 69. The outputs of the comparators A3 to An-2 to which the timing setting values TS3 to TSn-2 are input are omitted here.

When the first reference clock in one scanning period is input at a timing T10, the counter circuit 40 outputs the count value of “1”. When the count value “1” is output, the output of the comparator A1 where the timing setting value TS1 is 1 is in high level with some delay. The output of the OR circuit 41 is also in high level in accordance with the output change of the comparator A1. The output of the OR circuit 41 is taken into the intermittent clock generating circuit 42 in a second reference clock input at a timing T11. Accordingly, the intermittent clock is in high level.

When the second reference clock is input at a timing T11, the output of the counter circuit 40 is “2”. Therefore, all the outputs of the comparators A1 to An-1 are in low level. Accordingly, the output of the OR circuit 41 is in low level, and the intermittent clock is in low level when a third reference clock is input.

As stated above, the intermittent clock generating part 23 counts the number of reference clocks input in one scanning period, and keeps the ALL signal generated when the count value and the timing setting value are equal to each other high level based on the reference clock. In other words, the intermittent clock generating part 23 generates the intermittent clock synchronized with the reference clock and where the clock high-level output timing (or clock interval) is set based on the timing setting value. The timing setting value is for setting the clock interval of the intermittent clock. By changing the timing setting value, the number of generated clocks and the clock high-level output timing of the intermittent clock output by the intermittent clock generating part 23 can be changed.

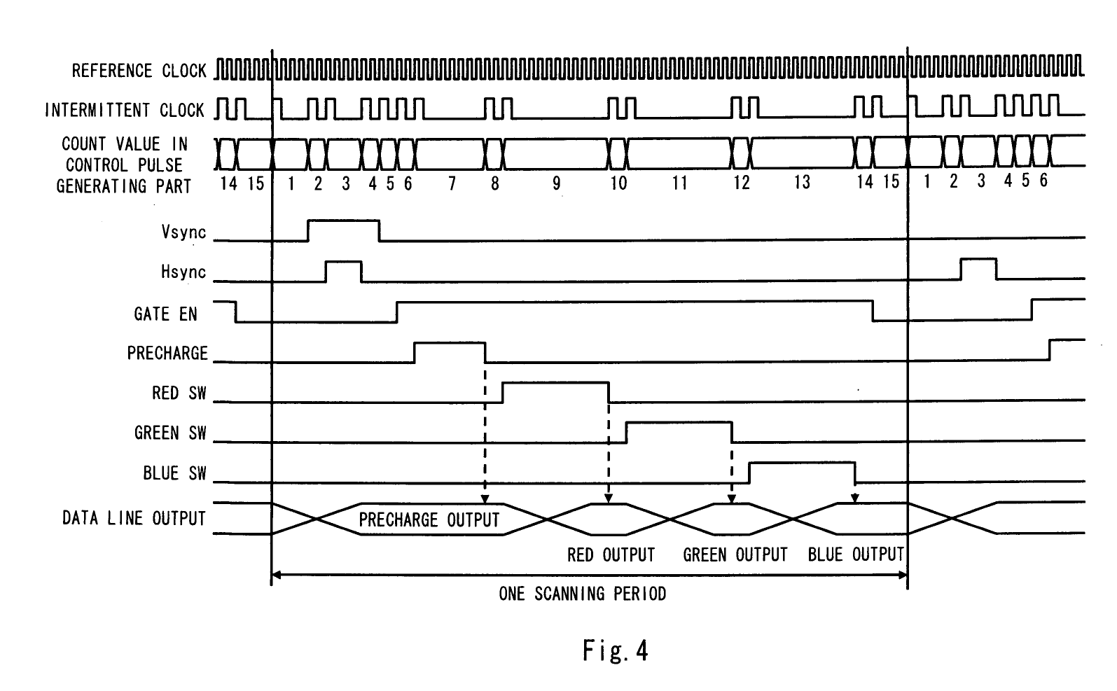

Now, the operations of the control pulse generating part 24, the data line controller 27, and the scan line controller 28 based on the intermittent clock generated by the intermittent clock generating circuit 42 will be described. FIG. 4 shows a timing chart of the operations of the control pulse generating part 24, the data line controller 27, and the scan line controller 28. As shown in FIG. 4, the control pulse generating part 24 counts the number of clocks of the intermittent clock in one scanning period, and rises and falls the control pulse according to the count value. In the present embodiment, the control pulse generating part 24 includes a vertical synchronizing signal Vsync, a horizontal synchronizing signal Hsync, a gate EN signal, a precharge control signal, a RED_SW control signal, a GREEN_SW control signal, and a BLUE_SW control signal as the control pulse. The data line controller 27 performs data line output which is the gradation signal supplied to the pixels.

The vertical synchronizing signal Vsync is the signal designating scanning of the first pixel rows of the pixel rows of the liquid crystal panel 3. When the vertical synchronizing signal Vsync is in high level, the scan line controller selects the first pixel row. The horizontal synchronizing signal Hsync changes the pixel row selected by the scan line controller 28. When the horizontal synchronizing signal Hsync is in high level, the scan line controller 28 selects the next pixel row. When both the vertical synchronizing signal Vsync and the horizontal synchronizing signal Hsync are input, the scan line controller 28 selects the first pixel row.

The gate EN signal is the signal designating the period during which the conduction state of the switch of the pixels can be controlled. When the gate EN signal is in high level, the data line controller 27 and the scan line controller 28 can control the pixels. The precharge control signal designates the period during which the potential of the data line connected to the pixel is reset to precharge voltage. When the precharge control signal is in high level, the data line controller 27 outputs the precharge voltage to the data line. The scan line controller 28 sets the switch between the data line and the line supplying the precharge voltage from the data line controller to conduction state, so that the precharge voltage is transmitted to the data line.

The RED_SW control signal designates the period during which the red gradation signal (RED output) is supplied to the red pixels. When the RED_SW control signal is in high level, the data line controller 27 outputs the red gradation signal to the data line. The scan line controller 28 sets the switch between the red pixel and the data line to conduction state. The GREEN_SW control signal designates the period during which the green gradation signal (GREEN output) is supplied to the green pixels. When the GREEN_SW control signal is in high level, the data line controller 27 outputs the green gradation signal to the data line. The scan line controller 28 sets the switch between the green pixel and the data line to the conduction state. The BLUE_SW control signal designates the period during which the blue gradation signal (BLUE output) is supplied to the blue pixels. When the BLUE_SW control signal is in high level, the data line controller 27 outputs the blue gradation signal to the data line. The scan line controller 28 sets the switch between the blue pixel and the data line to the conduction state.

As shown in FIG. 4, the control pulse is changed based on the count value of the intermittent clock. The control pulse timing setting register stores the timing information as to which signal is to be changed by which intermittent clock. The control pulse generating part 24 controls each of the control pulses according to the timing information.

In the example shown in FIG. 4, the vertical synchronizing signal Vsync rises when the count value of the intermittent clock is 2, and falls when the count value of the intermittent clock is 5. The horizontal synchronizing signal Hsync rises when the count value of the intermittent clock is 3, and falls when the count value of the intermittent clock is 4. The gate EN signal rises when the count value of the intermittent clock is 6, and falls when the count value of the intermittent clock is 15. The precharge control signal rises when the count value of the intermittent clock is 7, and falls when the count value of the intermittent clock is 8. The RED_SW control signal rises when the count value of the intermittent clock is 9, and falls when the count value of the intermittent clock is 10. The GREEN_SW control signal rises when the count value of the intermittent clock is 11, and falls when the count value of the intermittent clock is 12. The BLUE_SW control signal rises when the count value of the intermittent clock is 13, and falls when the count value of the intermittent clock is 14.

In summary, the timing setting value stored in the clock interval setting register 21b corresponds to the timing at which the control pulse is changed in one scanning period. Further, the timing at which the control pulse changes can be set appropriately by changing the timing setting value.

From the above description, in the display controller 2 according to the first embodiment, the intermittent clock generating part 23 generates the intermittent clock having less clock than the reference clock. Then the control pulse generating part 24 generates the control pulse based on the intermittent clock. Accordingly, in the control pulse generating part 24 of the first embodiment, since the control pulse is generated based on the intermittent clock of low frequency, the power consumption can further be reduced compared with the related timing generating part 124. The power consumption is generally calculated by a product of the number of elements forming the circuit, the amplitude of the clock, and the frequency of the clock. For example, if the control pulse generating part 24 of the present embodiment and the related timing generating part 124 have substantially the same number of elements and use the clock signal having the same amplitude, the intermittent clock input to the control pulse generating part 24 of the present embodiment has the frequency of 15/72 of the reference clock (the number of clocks of the intermittent clock output in one scanning period/the number of clocks of the reference clock input in one scanning period). Therefore, the power consumption of the control pulse generating part 24 of the present embodiment is reduced by 5/24 compared with the related timing generating part 124.

Further, if the pixel row that is displayed increases by 1.5 times, and the frequency of the reference clock is doubled, the power consumption is simply doubled in the related timing generating part 124. On the other hand, according to the control pulse generating part 24 of the present embodiment, the intermittent clock input in one scanning period is not changed and only the number of one scanning period in one frame period increases. Therefore, the power consumption only increases corresponding to the increased amount of pixel row. In summary, in this case, the power consumption of the control pulse generating part 24 in the present embodiment is 1.5 times larger than the case where the pixel row does not increase.

Since the intermittent clock generating part 23 according to the present embodiment operates based on the reference clock, the power consumption increases in accordance with the increase in the frequency of the reference clock. However, the circuit which operates based on the reference clock is only the counter circuit 40 and the intermittent clock generating circuit 42, which means the circuit size is quite small. Therefore, the increased amount of the power consumption of the intermittent clock generating part 23 can be quite small even when the frequency of the reference clock increases.

Hence, according to the display controller 2 of the present embodiment, not only the power consumed by the control pulse generating part 24 can be made small due to the use of the intermittent clock, but the power consumption which increases in accordance with the pixel row that is displayed can also be reduced.

On the other hand, the timing setting value setting the timing of the intermittent pulse and the setting value setting the timing of the control pulse can be changed from an external device. In summary, the setting value in accordance with the display state of the liquid crystal panel 3 can be appropriately changed from the external device. Accordingly, by setting the optimal clock state in accordance with the display state of the liquid crystal panel 3, the power consumption can be properly reduced.

Although not described in the above description, the timing setting value input to the intermittent clock generating part 23 is preferably not set with respect to the count value of the successive reference clocks. When the timing setting value is set with respect to the count value of the successive reference clocks, there is no low-level period between the intermittent clocks. If such a case happens, since the control pulse generating part 24 cannot generate the timing that is needed, the display data may not be appropriately displayed. In order to avoid such a problem, the number of clocks of the reference clock input in one scanning period is made more than twice as much as the number of the timing setting values, and the timing setting value is not set with respect to the count value of the successive reference clocks. This may be performed by software such as firmware or error processing may be executed when such a situation is occurred in the timing setting value generated by CPU or the like, for example. It is also possible to prevent the timing setting value from being set with respect to the count value of the successive reference clocks by storing the timing setting value only in even number registers in the clock interval setting register 21b.

It is apparent that the present invention is not limited to the above embodiments, but may be modified and changed without departing from the scope and spirit of the invention. For example, the control signal generated by the control pulse generating part is not limited to the signal of the above embodiment but can be changed in accordance with the system or the liquid crystal panel.

What is claimed is:

1. A display controller comprising:
a control pulse generating part outputting control pulse to a data line controller and a scan line controller driving a display panel; and
an intermittent clock generating part generating an intermittent clock synchronized with a reference clock and setting a clock interval based on a timing setting value setting a timing at which the control pulse changes in a predetermined period.

2. The display controller according to claim 1, further comprising a first setting register storing the timing setting value and a second setting register storing a relation between a timing at which the control pulse changes and a number of clocks of the intermittent clock input in a predetermined period.

3. The display controller according to claim 1, wherein the timing setting value is a value defining a relation between a number of clocks of the reference clock input in a predetermined period and a timing at which the control pulse changes in the predetermined period.

4. The display controller according to claim 1, wherein the reference clock has a frequency twice as much as a frequency of the intermittent clock.

5. The display controller according to claim 2, wherein the values stored in the first and second setting registers are changed based on data input from an outside.

6. The display controller according to claim 1, wherein the control pulse includes a plurality of control signals, and each of the plurality of control signals changes a signal level based on the intermittent clock.

7. The display controller according to claim 1, further comprising:
a reference clock generating part dividing a frequency of an original clock input from an outside or generated inside to generate the reference clock; and
a control register storing a setting of a frequency dividing ratio of the reference clock generating part.

8. The display controller according to claim 1, wherein the data line controller drives pixels arranged in columns in the display panel, and the scan line controller drives pixels arranged in rows in the display panel.

9. A method of controlling a display controller controlling a data line controller and a scan line controller driving a display panel by using a control pulse, the method comprising:
generating an intermittent clock synchronized with a reference clock and including an interval based on a timing setting value setting a timing at which the control pulse changes, and
generating the control pulse based on the intermittent clock.
